(19) United States
(12) Patent Application Publication
(10) Pub. No.: US 2025/0322214 A1
(43) Pub. Date: Oct. 16, 2025

(54) SELF-CRITICIZING ARTIFICIAL INTELLIGENCE SYSTEM

(71) Applicant: Google LLC, Mountain View, CA (US)

(72) Inventors: Haifeng Gong, Fremont, CA (US); Yang Li, Palo Alto, CA (US); Gang Li, Mountain View, CA (US); Yicong Tian, Mountain View, CA (US); Feng Yang, Sunnyvale, CA (US); Junjie Ke, East Palo Alto, CA (US); Effrosyni Kokiopoulou, Zurich (CH); Dongdong Wang, Sunnyvale, CA (US); Xiaohang Li, Cupertino, CA (US)

(21) Appl. No.: 18/634,586

(22) Filed: Apr. 12, 2024

(51) Int. Cl. G06N 3/0475; G06N 3/092

(52) U.S. Cl. CPC G06N 3/0475; G06N 3/092

(57) ABSTRACT

One example method includes generating, by an artificial intelligence (AI) system, a digital component using a first generative model; generating, by the AI system, a summary of the digital component using a second generative model, the summary of the digital component indicating contents comprised in the digital component; generating, by the AI system, an evaluation result of the digital component using the second generative model, the evaluation result of the digital component indicating one or more suggestions for improving the digital component; and refining, by the AI system and using the first generative model, the digital component based on the summary of the digital component and the evaluation result of the digital component.

### BACKGROUND

This specification relates to data processing and self-criticizing artificial intelligence (AI) system.

Advances in machine learning (ML) enable AI to be implemented in more applications. For example, a generative model is a type of ML model that aims to learn and mimic an underlying distribution of a given dataset. Unlike discriminative models that focus on classifying data into predefined categories, generative models are designed to generate new data that resembles the original training data. Generative models are used in various applications, such as image generation, text synthesis, and data augmentation.

### SUMMARY

In general, one innovative aspect of the subject matter described in this specification can be embodied in methods that include the actions of generating, by an artificial intelligence (AI) system, a digital component using a first generative model; generating, by the AI system, a summary of the digital component using a second generative model, the summary of the digital component indicating contents included in the digital component; generating, by the AI system, an evaluation result of the digital component using the second generative model, the evaluation result of the digital component indicating one or more suggestions for improving the digital component; and refining, by the AI system and using the first generative model, the digital component based on the summary of the digital component and the evaluation result of the digital component.

These and other embodiments can each optionally include one or more of the following features.

In some implementations, methods include generating, by the AI system, a policy review result of the digital component using the second generative model, the policy review result of the digital component indicating whether the digital component includes restricted content, where refining the digital component includes refining, by the AI system and using the first generative model, the digital component based on the summary of the digital component, the evaluation result of the digital component, and the policy review result of the digital component.

In some implementations, methods include determining, by the AI system and using the second generative model, one or more entity attributes of an entity associated with the digital component; determining, by the AI system and using the second generative model, one or more digital component attributes of the digital component; and generating, by the AI system and using the second generative model, an attribute review result of the digital component based on comparing the one or more entity attributes of the entity and the one or more digital component attributes of the digital component, where refining the digital component includes refining, by the AI system, the digital component based on the summary of the digital component, the evaluation result of the digital component, and the attribute review result of the digital component.

In some implementations, methods include generating, by the AI system and using the second generative model, a performance evaluation result of the digital component, where refining the digital component include refining, by the AI system, the digital component based on the summary of the digital component, the evaluation result of the digital component, and the performance evaluation result of the digital component.

In some implementations, the performance evaluation result of the digital component includes at least one of a predicted clickthrough rate (CTR) or a predicted conversion rate (CVR).

In some implementations, a refined digital component is generated based on refining the digital component, and where the methods include determining, by the AI system and using the second generative model, whether the refined digital component satisfies one or more conditions.

In some implementations, the methods include in response to determining that the refined digital component satisfies the one or more conditions, outputting, by the AI system, the refined digital component.

In some implementations, the methods include in response to determining that the refined digital component does not satisfy the one or more conditions: generating, by the AI system, a summary of the refined digital component using the second generative model; generating, by the AI system, an evaluation result of the refined digital component using the second generative model; and refining, by the AI system and using the first generative model, the refined digital component based on the summary of the refined digital component and the evaluation result of the refined digital component.

In some implementations, the methods include generating, by the AI system, training data including a training digital component and one or more suggestions for improving the training digital component; and training, by the AI system, the second generative model using the training data.

In some implementations, the methods include generating, by the AI system, training data including the digital component and the one or more suggestions for improving the digital component; and refining, by the AI system, the first generative model using the training data.

In some implementations, the methods include displaying, by the AI system, one or more pointers pointing to one or more regions of the digital component, the one or more regions of the digital component associated with the one or more suggestions for improving the digital component.

In some implementations, the one or more suggestions for improving the digital component include identifications of pixels to be improved.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment for using a generative model to evaluate artificial intelligence (AI)-generated digital components and generate critique results for refining the digital components, according to an implementation of the present disclosure.

FIG. 2 is a block diagram illustrating interactions between an AI system, two generative models, and a client device implementing innovative aspects of this specification.

FIG. 3 is a flow chart of an example process for using a generative model to evaluate AI-generated digital components and generate critique results for refining the digital components, according to an implementation of the present disclosure.

FIG. 4 shows an example digital component that is evaluated by a generative model, according to an implementation of the present disclosure.

FIG. 5 shows another example digital component that is evaluated by a generative model, according to an implementation of the present disclosure.

FIG. 6 is a block diagram of an example computer system that can be used to perform operations disclosed by this specification.

Like reference numbers and designations in the various drawings indicate like elements.

### DETAILED DESCRIPTION

This specification describes techniques for using a generative model to evaluate artificial intelligence (AI)-generated digital components and generate critique results for refining the digital components. Various modifications, alterations, and permutations of the disclosed implementations can be made and will be readily apparent to those of ordinary skill in the art, and the general principles defined can be applied to other implementations and applications, without departing from the scope of the present disclosure. In some instances, one or more technical details that are unnecessary to obtain an understanding of the described subject matter and that are within the skill of one of ordinary skill in the art may be omitted so as to not obscure one or more described implementations. The present disclosure is not intended to be limited to the described or illustrated implementations, but to be accorded the widest scope consistent with the described principles and features.

AI is a segment of computer science that focuses on the creation of models that can perform tasks act autonomously (e.g., with little to no human intervention). AI systems can utilize, for example, one or more of machine learning (ML), natural language processing, or computer vision. ML, and its subsets, such as deep learning, focus on developing models that can infer outputs from data. The outputs can include, for example, predictions and/or classifications. Natural language processing, focuses on analyzing and generating human language. Computer vision focuses on analyzing and interpreting images and videos. AI systems can include generative models that generate new content, such as images, videos, text, audio, and/or other content, in response to input prompts and/or based on other information.

While a generative model can be employed to generate digital components, a digital component generated by the generative model typically requires a lengthy iterative process of evaluation and revision before it can be distributed. In each iteration, designers can evaluate the digital component and provide feedback to the generative model for improvement. However, this manual process slows down the iteration process, reducing the efficiency of digital component generation. Furthermore, human designers may not discern subtle differences in the digital components, such as at the pixel level.

To address these issues, in some cases, the techniques described throughout this specification enable an AI system to use a generative model to evaluate a digital component generated by another generative model in an iterative process. In each iteration, the generative model can evaluate the AI-generated digital component by executing various tasks (e.g., content understanding task, user experience evaluation task, policy review task, entity attribute review task, and/or performance understanding task) to generate critique results. The critique results can include a detailed assessment of the strengths and weaknesses of the digital component. The critique results can then be fed back to the generative model that generated the digital component, which can subsequently refine the digital component based on the critique results. This evaluation and revision process can be repeated multiple times until the digital component satisfies one or more conditions (e.g., an overall score of the digital component satisfies a predetermined threshold).

Further, the techniques described throughout this specification enable a generative model to receive feedback on its output from another generative model autonomously, without requiring human intervention. This feedback can serve as training data to enhance the generative model's ability to create new digital components. Therefore, the techniques described throughout this specification enable the training of a generative model without relying on human feedback.

The techniques described herein can be implemented to achieve the following advantages. In some cases, an AI system can employ a generative model to assess a digital component created by another generative model through an iterative process. This assessment is then provided to the originating generative model, which can refine the digital component based on this feedback. Compared to relying on manual evaluations that slow down an iterative process, the techniques described herein can improve the efficiency of digital component generation.

In some cases, the generative model can provide suggestions on improving the digital components at the pixel level. For example, in some implementations, the generative model can pinpoint and recommend adjustments to specific pixels. This capability compensates for the limitations of human vision, which may not be able to discern subtle differences in digital components, particularly at the pixel level. This finer level of analysis ensures that the suggestions provided are detailed and actionable, resulting in more effective enhancements in digital component generation.

In some cases, the techniques described herein enable to automatically train a generative model using the feedback of another generative model. Compared to relying on human feedback, the automated feedback loop significantly enhances the training efficiency of generative models. Also, the feedback loop enables the generative model to generate more digital components similar to the ones that received positive outcomes and to avoid generating digital components similar to the ones that received negative outcomes. This can reduce the rejections of undesirable, low-quality digital components, and thus reduce wasted computing resources that would be used to, for example, generate and evaluate the low-quality digital components and/or regenerate digital components.

In some cases, the techniques described herein enable the performance of multiple tasks in evaluating a digital component. For instance, the generative model can execute at least two tasks, such as content understanding, user experience evaluation, policy review, entity attribute review, and/or performance understanding, to generate more detailed critique results. Unlike executing a single task, multi-task execution can yield critique results with greater granularity. For example, combining the content understanding and user experience evaluation tasks allows the generative model to identify the contents of a digital component before evaluating it based on those specifics. This capability enables the generative model to conduct chain-of-thoughts (CoT) analysis.

As used throughout this document, the phrase “digital component” refers to a discrete unit of digital content or digital information (e.g., a video clip, audio clip, multimedia clip, gaming content, image, text, bullet point, AI output, language model output, or another unit of content). A digital component can electronically be stored in a physical memory device as a single file or in a collection of files, and digital components can take the form of video files, audio files, multimedia files, image files, or text files and include advertising information, such that an advertisement is a type of digital component.

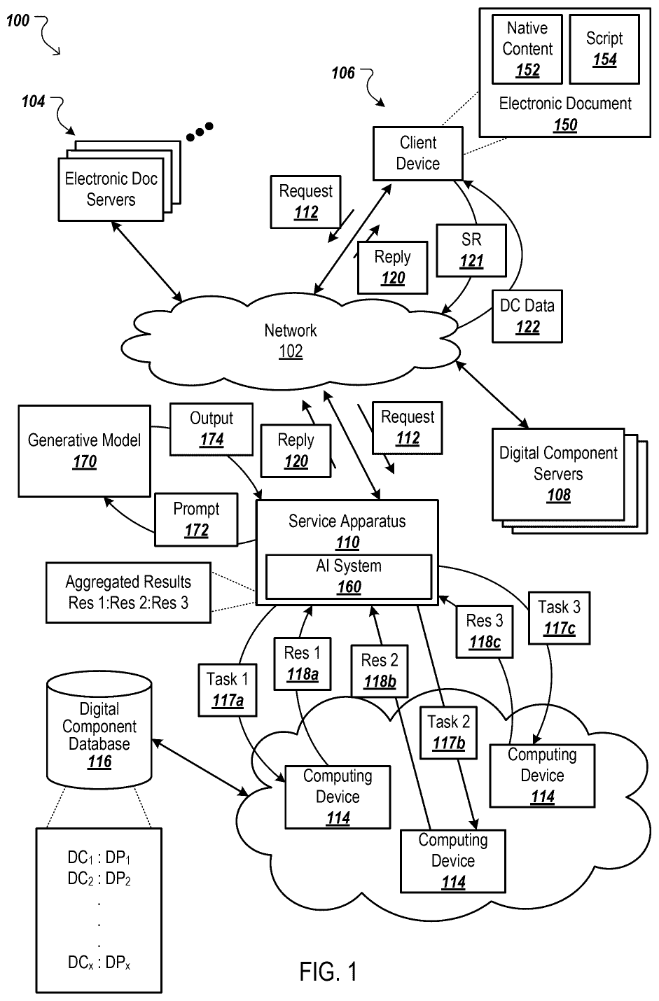

FIG. 1 is a block diagram of an example environment 100 for using a generative model to evaluate AI-generated digital components and generate critique results for refining the digital components, according to an implementation of the present disclosure. The example environment 100 includes a network 102, such as a local area network (LAN), a wide area network (WAN), the Internet, or a combination thereof. The network 102 connects electronic document servers 104, client devices 106, digital component servers 108, and a service apparatus 110. The example environment 100 may include many different electronic document servers 104, client devices 106, and digital component servers 108.

A client device 106 is an electronic device capable of requesting and receiving online resources over the network 102. Example client devices 106 include personal computers, gaming devices, mobile communication devices, digital assistant devices, augmented reality devices, virtual reality devices, and other devices that can send and receive data over the network 102. A client device 106 typically includes a user application, such as a web browser, to facilitate the sending and receiving of data over the network 102, but native applications (other than browsers) executed by the client device 106 can also facilitate the sending and receiving of data over the network 102.

A gaming device is a device that enables a user to engage in gaming applications, for example, in which the user has control over one or more characters, avatars, or other rendered content presented in the gaming application. A gaming device typically includes a computer processor, a memory device, and a controller interface (either physical or visually rendered) that enables user control over content rendered by the gaming application. The gaming device can store and execute the gaming application locally or execute a gaming application that is at least partly stored and/or served by a cloud server (e.g., online gaming applications). Similarly, the gaming device can interface with a gaming server that executes the gaming application and “streams” the gaming application to the gaming device. The gaming device may be a tablet device, mobile telecommunications device, a computer, or another device that performs other functions beyond executing the gaming application.

Digital assistant devices include devices that include a microphone and a speaker. Digital assistant devices are generally capable of receiving input by way of voice, and respond with content using audible feedback, and can present other audible information. In some situations, digital assistant devices also include a visual display or are in communication with a visual display (e.g., by way of a wireless or wired connection). Feedback or other information can also be provided visually when a visual display is present. In some situations, digital assistant devices can also control other devices, such as lights, locks, cameras, climate control devices, alarm systems, and other devices that are registered with the digital assistant device.

As illustrated, the client device 106 is presenting an electronic document 150. An electronic document is data that presents a set of content at a client device 106. Examples of electronic documents include webpages, word processing documents, portable document format (PDF) documents, images, videos, search results pages, and feed sources. Native applications (e.g., “apps” and/or gaming applications), such as applications installed on mobile, tablet, or desktop computing devices are also examples of electronic documents. Electronic documents can be provided to client devices 106 by electronic document servers 104 (“Electronic Doc Servers”).

For example, the electronic document servers 104 can include servers that host publisher websites. In this example, the client device 106 can initiate a request for a given publisher webpage, and the electronic document server 104 that hosts the given publisher webpage can respond to the request by sending machine executable instructions that initiate presentation of the given webpage at the client device 106.

In another example, the electronic document servers 104 can include app servers from which client devices 106 can download apps. In this example, the client device 106 can download files required to install an app at the client device 106, and then execute the downloaded app locally (i.e., on the client device). Alternatively, or additionally, the client device 106 can initiate a request to execute the app, which is transmitted to a cloud server. In response to receiving the request, the cloud server can execute the application and stream a user interface of the application to the client device 106 so that the client device 106 does not have to execute the app itself. Rather, the client device 106 can present the user interface generated by the cloud server's execution of the app and communicate any user interactions with the user interface back to the cloud server for processing.

Electronic documents can include a variety of content. For example, an electronic document 150 can include native content 152 that is within the electronic document 150 itself and/or does not change over time. Electronic documents can also include dynamic content that may change over time or on a per-request basis. For example, a publisher of a given electronic document (e.g., electronic document 150) can maintain a data source that is used to populate portions of the electronic document. In this example, the given electronic document can include a script, such as the script 154, that causes the client device 106 to request content (e.g., a digital component) from the data source when the given electronic document is processed (e.g., rendered or executed) by a client device 106 (or a cloud server). The client device 106 (or cloud server) integrates the content (e.g., digital component) obtained from the data source into the given electronic document to create a composite electronic document including the content obtained from the data source.

In some situations, a given electronic document (e.g., electronic document 150) can include a digital component script (e.g., script 154) that references the service apparatus 110, or a particular service provided by the service apparatus 110. In these situations, the digital component script is executed by the client device 106 when the given electronic document is processed by the client device 106. Execution of the digital component script configures the client device 106 to generate a request for digital components 112 (referred to as a “component request”), which is transmitted over the network 102 to the service apparatus 110. For example, the digital component script can enable the client device 106 to generate a packetized data request including a header and payload data. The component request 112 can include event data specifying features such as a name (or network location) of a server from which the digital component is being requested, a name (or network location) of the requesting device (e.g., the client device 106), and/or information that the service apparatus 110 can use to select one or more digital components, or other content, provided in response to the request. The component request 112 is transmitted, by the client device 106, over the network 102 (e.g., a telecommunications network) to a server of the service apparatus 110.

The component request 112 can include event data specifying other event features, such as the electronic document being requested and characteristics of locations of the electronic document at which digital component can be presented. For example, event data specifying a reference (e.g., a Uniform Resource Locator (URL)) to an electronic document (e.g., webpage) in which the digital component will be presented, available locations of the electronic documents that are available to present digital components, sizes of the available locations, and/or media types that are eligible for presentation in the locations can be provided to the service apparatus 110. Similarly, event data specifying keywords associated with the electronic document (“document keywords”) or entities (e.g., people, places, or things) that are referenced by the electronic document can also be included in the component request 112 (e.g., as payload data) and provided to the service apparatus 110 to facilitate identification of digital components that are eligible for presentation with the electronic document. The event data can also include a search query that was submitted from the client device 106 to obtain a search results page.

Component requests 112 can also include event data related to other information, such as information that a user of the client device has provided, geographic information indicating a state or region from which the component request was submitted, or other information that provides context for the environment in which the digital component will be displayed (e.g., a time of day of the component request, a day of the week of the component request, a type of device at which the digital component will be displayed, such as a mobile device or tablet device). Component requests 112 can be transmitted, for example, over a packetized network, and the component requests 112 themselves can be formatted as packetized data having a header and payload data. The header can specify a destination of the packet and the payload data can include any of the information discussed above.

The service apparatus 110 chooses digital components (e.g., third-party content, such as video files, audio files, images, text, gaming content, augmented reality content, and combinations thereof, which can all take the form of advertising content or non-advertising content) that will be presented with the given electronic document (e.g., at a location specified by the script 154) in response to receiving the component request 112 and/or using information included in the component request 112.

In some implementations, a digital component is selected in less than a second to avoid errors that could be caused by delayed selection of the digital component. For example, delays in providing digital components in response to a component request 112 can result in page load errors at the client device 106 or cause portions of the electronic document to remain unpopulated even after other portions of the electronic document are presented at the client device 106.

Also, as the delay in providing the digital component to the client device 106 increases, it is more likely that the electronic document will no longer be presented at the client device 106 when the digital component is delivered to the client device 106, thereby negatively impacting a user's experience with the electronic document. Further, delays in providing the digital component can result in a failed delivery of the digital component, for example, if the electronic document is no longer presented at the client device 106 when the digital component is provided.

In some implementations, the service apparatus 110 is implemented in a distributed computing system that includes, for example, a server and a set of multiple computing devices 114 that are interconnected and identify and distribute digital component in response to requests 112. The set of multiple computing devices 114 operate together to identify a set of digital components that are eligible to be presented in the electronic document from among a corpus of millions of available digital components (DC₁₋ₓ). The millions of available digital components can be indexed, for example, in a digital component database 116. Each digital component index entry can reference the corresponding digital component and/or include distribution parameters (DP₁-DPₓ) that contribute to (e.g., trigger, condition, or limit) the distribution/transmission of the corresponding digital component. For example, the distribution parameters can contribute to (e.g., trigger) the transmission of a digital component by requiring that a component request include at least one criterion that matches (e.g., either exactly or with some pre-specified level of similarity) one of the distribution parameters of the digital component.

In some implementations, the distribution parameters for a particular digital component can include distribution keywords that must be matched (e.g., by electronic documents, document keywords, or terms specified in the component request 112) in order for the digital component to be eligible for presentation. Additionally, or alternatively, the distribution parameters can include embeddings that can use various different dimensions of data, such as website details and/or consumption details (e.g., page viewport, user scrolling speed, or other information about the consumption of data). The distribution parameters can also require that the component request 112 include information specifying a particular geographic region (e.g., country or state) and/or information specifying that the component request 112 originated at a particular type of client device (e.g., mobile device or tablet device) in order for the digital component to be eligible for presentation. The distribution parameters can also specify an eligibility value (e.g., ranking score, or some other specified value) that is used for evaluating the eligibility of the digital component for distribution/transmission (e.g., among other available digital components).

The identification of the eligible digital component can be segmented into multiple tasks 117a-117c that are then assigned among computing devices within the set of multiple computing devices 114. For example, different computing devices in the set 114 can each analyze a different portion of the digital component database 116 to identify various digital components having distribution parameters that match information included in the component request 112. In some implementations, each given computing device in the set 114 can analyze a different data dimension (or set of dimensions) and pass (e.g., transmit) results (Res 1-Res 3) 118a-118c of the analysis back to the service apparatus 110. For example, the results 118a-118c provided by each of the computing devices in the set 114 may identify a subset of digital components that are eligible for distribution in response to the component request and/or a subset of the digital component that have certain distribution parameters. The identification of the subset of digital components can include, for example, comparing the event data to the distribution parameters, and identifying the subset of digital components having distribution parameters that match at least some features of the event data.

The service apparatus 110 aggregates the results 118a-118c received from the set of multiple computing devices 114 and uses information associated with the aggregated results to select one or more digital components that will be provided in response to the request 112. For example, the service apparatus 110 can select a set of winning digital components (one or more digital components) based on the outcome of one or more content evaluation processes, as discussed below. In turn, the service apparatus 110 can generate and transmit, over the network 102, reply data 120 (e.g., digital data representing a reply) that enable the client device 106 to integrate the set of winning digital components into the given electronic document, such that the set of winning digital components (e.g., winning third-party content) and the content of the electronic document are presented together at a display of the client device 106.

In some implementations, the client device 106 executes instructions included in the reply data 120, which configures and enables the client device 106 to obtain the set of winning digital components from one or more digital component servers 108. For example, the instructions in the reply data 120 can include a network location (e.g., a URL) and a script that causes the client device 106 to transmit a server request (SR) 121 to the digital component server 108 to obtain a given winning digital component from the digital component server 108. In response to the request, the digital component server 108 will identify the given winning digital component specified in the server request 121 (e.g., within a database storing multiple digital components) and transmit, to the client device 106, digital component data 122 that presents the given winning digital component in the electronic document at the client device 106.

When the client device 106 receives the digital component data 122, the client device will render the digital component (e.g., third-party content), and present the digital component at a location specified by, or assigned to, the script 154. For example, the script 154 can create a walled garden environment, such as a frame, that is presented within, e.g., beside, the native content 152 of the electronic document 150. In some implementations, the digital component is overlaid over (or adjacent to) a portion of the native content 152 of the electronic document 150, and the service apparatus 110 can specify the presentation location within the electronic document 150 in the reply 120. For example, when the native content 152 includes video content, the service apparatus 110 can specify a location or object within the scene depicted in the video content over which the digital component is to be presented.

The service apparatus 110 can also include an AI system 160 configured to autonomously generate digital components, either prior to a request 112 (e.g., offline) and/or in response to a request 112 (e.g., online or real-time). As described in more detail throughout this specification, the AI system 160 can collect online content about a specific entity (e.g., digital component provider or another entity) and generate digital components based on the collected online content using one or more generative models 170.

Generative models are designed to generate new data that resembles a given training dataset and operate by learning underlying patterns, structures, and relationships present in the training dataset, enabling them to create new samples that share similar characteristics. The primary goal of generative models is to capture inherent complexity of a data distribution, allowing them to produce outputs that exhibit the same diversity and variability found in the original dataset.

One of the fundamental concepts in generative models is generation of data from random noise or latent variables. The generative models create a mapping between a latent space and data space, permitting generation of entirely novel instances that possess meaningful features. Generative models can be broadly categorized into two main types: likelihood-based and adversarial-based.

Likelihood-based generative models, such as Variational Autoencoders (VAEs) and Autoregressive Models, focus on learning the probability distribution of the data. VAEs, for instance, employ an encoder-decoder architecture to map data points into a latent space and then decode them back into the data space. This process encourages the model to learn a more structured and continuous representation of the data distribution.

Adversarial-based generative models, most notably Generative Adversarial Networks (GANs), leverage a different approach. GANs consist of two neural networks: a generator and a discriminator. The generator aims to produce data that is indistinguishable from real data, while the discriminator tries to distinguish between real and generated data. This adversarial process results in the generator improving over time and producing increasingly convincing outputs.

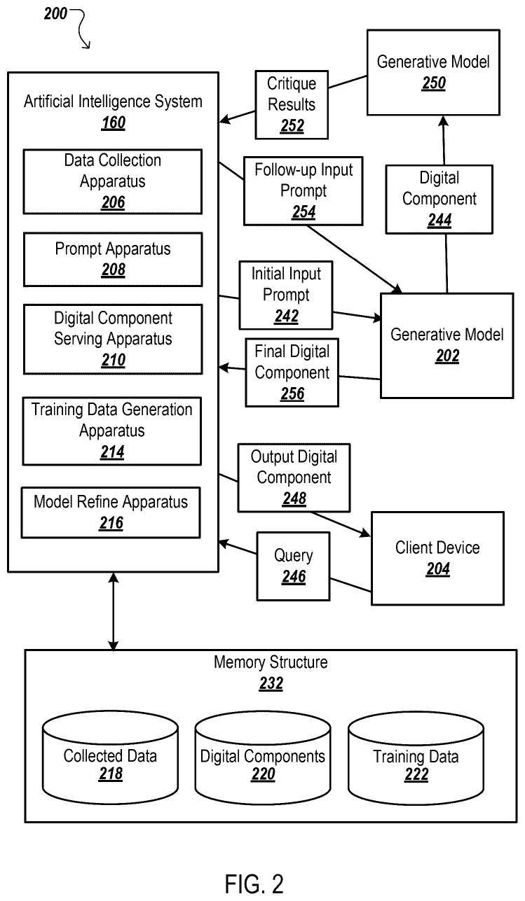

FIG. 2 is a block diagram of an example system 200 illustrating interactions between an AI system 160, a generative model 202, a generative model 250, and a client device 204, according to an implementation of the present disclosure. The system 200 is configured to evaluate, using the generative model 250, digital components generated by the generative model 202 and generate critique results for refining the digital components. The generative model 202 can use the critique results to refine the digital components. In some situations, generative model 202 and client device 204 can, respectively, be the same or similar to the generative model 170 and client device 106 of FIG. 1.

The generative model 202 can, for example, generate digital components. The generative model 202 can be, for example, a text-to-text generative model, a text-to-image generative model, a text-to-video generative model, an image-to-image generative model, or any other type of generative model. Although a single generative model 202 is depicted in FIG. 2, the generative model 202 can be a set of different generative models that can be invoked for different tasks for which the different generative models are specially trained. For example, one generative model within the set of generative models may be specially trained to perform content summary tasks, while another model may be specially trained to generate digital components, for example, using the output of the specially trained generative model that performs content summary tasks. Furthermore, the set of models can include a generalized generative model that is larger is size, and capable of generating large amounts of diverse datasets, but this generalized model may have higher latency than the specialized models, which can make it less desirable for use in real-time operations, depending on time latency constraints required to generate content.

The generative model 250 can, for example, evaluate the digital components generated by the generative model 202 and generate critique results for refining the digital components and/or the generative model 202. The generative model 250 can, for example, identify the strengths and weaknesses of a digital component generated by the generative model 202 and provide suggestions for improvement. The generative model 250 can also, for example, generate critiques that are both informative and actionable, and can help relevant personnels, such as engineers, to create more effective and compliant digital components. In some cases, the generative model 250 is a large language model (LLM), such as a text-to-text generative model, an image-to-text generative model, a video-to-text generative model, or any other type of generative model that can generate critiques for digital components. In some examples, the generative model 250 is trained on a dataset of digital components, such as images, design principles, user experience guidelines, and/or digital component policies.

In some cases, the generative model 250 is a single generative model (as depicted in FIG. 2), such as a multimodal LLM, that can perform a plurality of tasks. In some cases, different from the depiction of FIG. 2, the generative model 250 can be a set of different generative models that can be invoked for different tasks for which the different generative models are specially trained. For example, one generative model within the set of generative models may be specially trained to perform content summary tasks, while another model may be specially trained to generate critique results, for example, using the output of the specially trained generative model that performs content summary tasks. Furthermore, the set of models can include a generalized generative model that is larger is size, and capable of generating large amounts of diverse datasets, but this generalized model may have higher latency than the specialized models, which can make it less desirable for use in real-time operations, depending on time latency constraints required to generate content.

The AI system 160 includes a data collection apparatus 206, a prompt apparatus 208, a digital component serving apparatus 210, a training data generation apparatus 214, and a model refine apparatus 216. The following description refers to these different apparatuses as being implemented independently and each configured to perform a set of operations, but any of these apparatuses could be combined to perform the operations discussed below.

The AI system 160 is in communication with a memory structure 232. The memory structure 232, can include one or more databases. As shown, the memory structure 232 includes a collected data database 218, a digital components database 220, and a training data database 222. Each of these databases 218, 220, and 222 can be implemented in a same hardware memory device, separate hardware memory devices, and/or implemented in a distributed cloud computing environment.

The client device 204 can transmit a query 246 to the AI system 160. In some examples, a user can submit the query using a front-end interface of the AI system 160 (e.g., a website, or an application of a computing device). In some cases, the query 246 can be, for example, a request for the AI system 160 to generate a digital component. For example, a user can input a prompt to request the AI system 160 to generate an image, video, audio, or any suitable type of digital component.

In some cases, the user can upload, to the AI system 160, one or more original input digital components (e.g., images, text, and videos) associated with the query (whether as a part of the query or not), and the original digital component(s) can be used to create output digital components. For example, the original digital component(s) can be image(s) of a product, and the image(s) of the product can be included in one or more new or modified output digital components generated by the AI system 160.

In some implementations, the user can submit additional query data to the AI system 160, where the additional query data can include data not in the query and can limit digital components generated by the AI system 160. For example, the additional query data can include but not limited to, the geographic location(s) to which the output digital component will be distributed, a language used in the digital component, and/or a vertical industry that will be used to distribute the output digital component. For example, an advertiser can indicate that the digital component is aimed for distribution in North American markets, should be in English language, and/or is aimed at the fashion clothing vertical industry. In some examples, the user provides the additional query data in the same prompt that requests to generate the digital component. In other examples, the additional query data is input separately from the prompt. For example, the AI system 160 can generate one or more follow-up questions in response to the user's prompt, where the one or more follow-up questions are used to solicit input of the additional query data from the user. For example, the follow-up question(s) can be “which geographic location(s) will the digital component be distributed in,” “which language should the digital component be in,” and/or “which vertical market(s) should the digital component be directed to?”

In some examples, the AI system 160 can collect, using the data collection apparatus 206, additional query data not input directly by the user. The data collection apparatus 206 is implemented using at least one computing device (e.g., one or more processors), and can include one or more ML models. In some cases, the data collection apparatus 206 can obtain an identity of an entity associated with the query. The identity can include at least one identifier, such as a company or corporation name, a URL, a telephone number, employer ID number, or other means of identifying an entity. The data collection apparatus 206 can obtain the at least one identifier using, for example, an account of the user who submitted the query or from a partner system. The data collection apparatus 206 can automatically identify, based on the identity of the entity, a data source including information about the entity. These data sources can be, but are not limited to, web pages (e.g., the entity's landing page), review compilation pages (e.g., Google review, Yelp review, and Crunchbase review), federal and/or state registries (e.g., the Delaware entity search tool), private databases, news articles, or other suitable sources. In some implementations, a data crawler application automatically queries a plurality of databases, performs searches, and extracts information from the results in response to the process being triggered. The information obtained from these data sources can be bulk text data, a combination of text and images, metadata, or other suitable data and/or media.

In some examples, the data collection apparatus 206 can perform a semantic analysis of the collected information for at least one data source. In some implementations, a single data source is analyzed using semantic analysis. In some implementations, all collected information is analyzed. The semantic analysis can be performed by one or more ML algorithms with an overall objective of generating one or more entity attributes associated with the entity. In some cases, the data collection apparatus 206 can perform the semantic analysis using an array of neural networks that operate in series or can include ML algorithms that operate in parallel, or otherwise independently of each other. In some implementations, traditional data analysis can be performed in addition to, or separately from, the ML processes. Similar to the additional query data, the one or more entity attributes can include, for example, the geographic location(s) that a digital component will be distributed, a language used in the digital component, and/or a vertical industry that will be used to distribute the digital component. In some examples, the data collection apparatus 206 can include the one or more entity attributes in the additional query data.

The data collection apparatus 206 can store the collected data in the collected data database 218. For example, the data collection apparatus 206 can index the collected data to the query used to collect the data and/or an entity characterized by the collected data so that the collected data can be retrieved from the collected data database 218 for additional operations performed by the data collection apparatus 206 and/or any operations performed by the AI system 160.

The AI system 160 can generate, using the prompt apparatus 208, an initial input prompt 242 using the query 246 and/or additional query data. The prompt apparatus 208 can be implemented using at least one computing device (e.g., a device including one or more processors), and can include one or more language models. In some cases, the initial input prompt 242 can include the query 246 and a set of constraints generated based on, for example, the additional query data. For example, the prompt apparatus 208 can insert, into the initial input prompt 242, one or more of the entity attribute(s) corresponding to the entity as identified by the data collection apparatus 206. In some implementations, the one or more of the entity attribute(s) inserted into the prompt operates as a contextual constraint that limits content created by the generative model 202 responsive to the initial input prompt 242. For example, the entity attribute(s) can limit the content created by the generative model to subject matter specified by the entity attribute(s) that is included in the prompt as a contextual constraint.

The AI system 160 can transmit the initial input prompt 242 to the generative model 202. The generative model 202 can then generate, based on the initial input prompt 242, one or more digital components. In some cases, the AI system 160 can receive a plurality of original digital components (e.g., original images) associated with the query. The generative model 202 can generate a plurality of digital components using the original digital components, where each of the plurality of digital components includes at least one of the plurality of original digital components.

For example, assume that the query 246 is “Generate a digital component that includes sunglasses and a corresponding description” and the user uploaded an image of the sunglasses. Also assume that the additional query data indicates that the digital component is intended for distribution to users in Japan who are interested in the fashion clothing vertical market. The input prompt 242 can take the following form:

Generate a good_output: a digital component where the query is “Generate a digital component that includes sunglasses and a corresponding description.” The good_output should be directed to the fashion clothing vertical market in Japan.

In some cases, the generative model 202 can generate one digital component 244 as the model output. In other cases, the generative model 202 can generate multiple candidate digital components and the AI system 160 and/or the generative model 202 can select a digital component 244 out of the multiple candidate digital components as model output. For example, the generative model 202 can generate multiple candidate digital components including the image of the sunglasses and having different backgrounds. For example, a digital component can include a Fuji Mountain scene in the background, a digital component can include a snow scene in the background, a digital component can include a backyard scene in the background, and a digital component can include an Eiffel Tower scene in the background. The AI system 160 and/or the generative model 202 can select the digital component that includes a Fuji Mountain scene in the background as the model output.

The AI system 160 and/or the generative model 202 can store the generated digital components in the digital components database 220. For example, the AI system 160 and/or the generative model 202 can index the generated digital component(s) to the query used to generate the digital component(s) and/or an entity associated with the digital component(s), so that the digital component(s) can be retrieved from the digital components database 220 for additional operations performed by the AI system 160 and/or the generative model 202.

The generative model 202 can transmit the digital component 244 to the generative model 250, which can generate critique results 252 of the digital component 244. In some cases, the generative model 250 has built-in knowledge about digital components, including, for example, look-and-feel, user experience guidelines, design expertise, and/or performance understanding. The generative model 250 can evaluate the digital component 244 in multiple ways by performing a plurality of various tasks. For example, the generative model 250 can perform at least one of a content understanding task, a user experience evaluation task, a policy review task, an entity attribute review task, and/or a performance understanding task to generate the critique results 252.

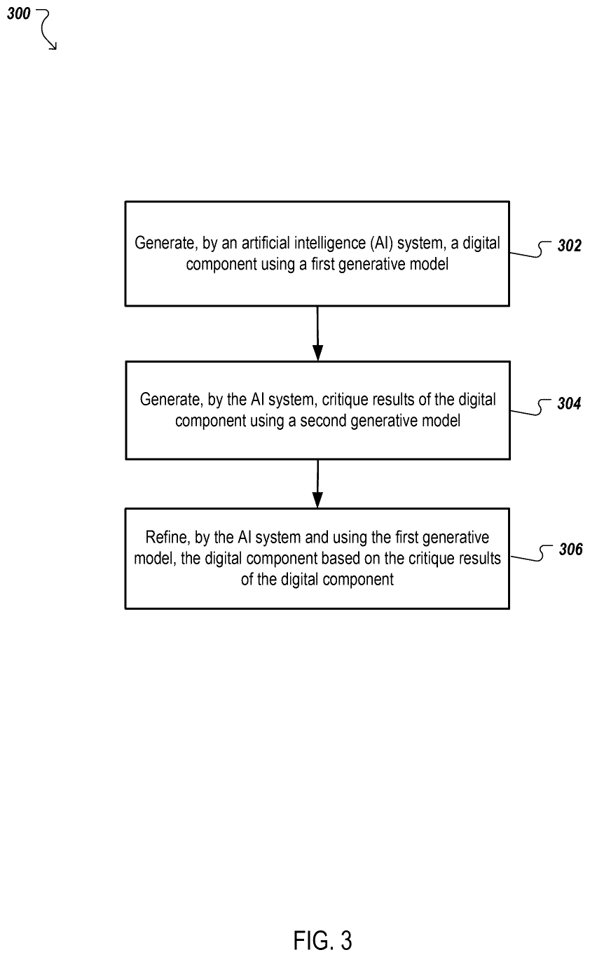

In the content understanding task, the generative model 250 can generate a summary of the digital component 244, the summary of the digital component 244 indicating contents included in the digital component 244. In the user experience evaluation task, the generative model 250 can generate an evaluation result of the digital component 244, the evaluation result of the digital component 244 indicating one or more suggestions for improving the digital component 244. In the policy review task, the generative model 250 can generate a policy review result of the digital component 244, the policy review result of the digital component 244 indicating whether the digital component 244 includes restricted content. In the entity attribute review task, the generative model 250 can generate an attribute review result of the digital component 244 based on comparing one or more entity attributes of an entity associated with the digital component 244 and one or more digital component attributes of the digital component 244. In the performance understanding task, the generative model 250 can generate a performance evaluation result of the digital component 244. The performance evaluation result of the digital component 244 can include at least one of a predicted clickthrough rate (CTR), a predicted conversion rate (CVR), or a predicted cost per day (CPD) of the digital component 244. The critique results 252 can include at least one of the summary of the digital component 244, the evaluation result of the digital component 244, the policy review result of the digital component 244, the attribute review result of the digital component 244, or the performance evaluation result of the digital component 244. More details are described with respect to FIG. 3.

The generative model 250 can transmit the critique results 252 to the AI system 160, which can generate, based on the critique results 252, a follow-up input prompt 254 that can be used by the generative model 202 to refine the digital component 244. In some cases, the critique results 252 can include one or more suggestions for improving the digital component 244. For example, assuming that the digital component 244 is an image, the critique results 252 can indicate that the headline text in the image does not have enough contrast with the image's background, which makes a user hard to discern the headline text in a quick glance. The AI system 160 can then include in the follow-up input prompt 254 an instruction for the generative model 202 to enhance the contrast of the headline text compared to the background.

In some cases, the critique results 252 indicate a weaknesses of the digital component 244 but do not explicitly indicate the suggestions for improvements. In such case, the AI system 160 can generate the suggestions for improvements based on the critique results 252. For example, the critique results 252 can indicate that the digital component 244 has relatively low prospect performance data, such as CTR, CVR, and/or CPD, but do not suggest how to improve the performance data. The AI system 160 can determine, from examining past high-performance digital components, the common attribute(s) of the past high-performance digital components and generate suggestions accordingly to improve the performance. So, for example, assume that a majority of the past high-performance digital components include animation, the AI system 160 can include in the follow-up input prompt 254 an instruction for the generative model 202 to add an animation in the digital component 244. Although not shown in FIG. 2, in some cases, the generative model 250 can transmit the critique results 252 to generative model 202 directly instead of passing the AI system 160.

Upon receiving the follow-up input prompt 254, the generative model 202 can refine the digital component 244 based on the follow-up input prompt 254. In some cases, the generative model 202 can retrieve the previously generated digital component 244 from the digital components database 220. In some cases, the generative model 202 can refine the digital component 244 by implementing the one or more suggestions included in the follow-up input prompt 254.

In some implementations, the generative model 202 can transmit the refined digital component to the generative model 250, which can then generate critique results of the refined digital component. The generative model 202 can then further refine the digital component using the critique results. In some cases, these operations can be repeated for multiple iterations until one or more conditions are satisfied.

In one example of the one or more conditions, the generative model 250 can be trained to generate an overall score of a digital component generated by the generative model 202, and the one or more conditions for terminating the iterations can include that the overall score satisfies (e.g., meets or exceeds) a predetermined threshold. In another example, the one or more conditions can include that a predetermined quantity of iterations has been performed. In some examples, if the one or more conditions are satisfied, the generative model 250 and/or the AI system 160 can instruct the generative model 202 to output the final digital component 256. On the other hand, if the one or more conditions are not satisfied, the generative model 250 can generate critique results again for the digital component, and the generative model 202 can refine the digital component again based on the critique results.

In some cases, the AI system 160 can generate an output digital component 248 using the final digital component 256, and transmit the output digital component 248 to the client device 204. In some implementations, the output digital component 248 is the same as the final digital component 256. In some implementations, the output digital component 248 is different from the final digital component 256. For example, the AI system 160 can combine a plurality of digital components including the final digital component 256 to generate the output digital component 248.

In some cases, the AI system 160 can serve, using the digital component serving apparatus 210, the final digital component 256 and/or the output digital component 248. The digital component serving apparatus 210 can be implemented using at least one computing device (e.g., a device including one or more processors), and can include one or more ML models. In some cases, the digital component serving apparatus 210 can perform rendering, including rendering and formatting the digital component to visually match/blend with the publisher's website or app layout. The digital component serving apparatus 210 can generate the necessary HyperText Markup Language (HTML), images, or video components to display the digital component. In some examples, the digital component serving apparatus 210 can perform digital component delivery—the rendered digital component is transmitted to the publisher's website or app, where it is displayed to the user in the designated digital component space.

In some examples, the digital component serving apparatus 210 can collect performance data of the digital components. In some implementations, the performance data can indicate acceptance levels of the digital components and can be used to evaluate and rank the digital components. The performance data can be based on, for example, user interactions with the digital components. For example, users may interact with the digital component by clicking on it, watching a video, purchasing a product promoted by the digital component, or taking other actions. Examples of performance data include but not limited to, CTR, CVR, CPD, and other user actions.

In some implementations, the AI system 160 generates, using the training data generation apparatus 214, training data based on the digital component 244 and/or the critique results 252. The training data generation apparatus 214 can be implemented using at least one computing device (e.g., a device including one or more processors), and can include one or more ML models. In some cases, the training data can be used to refine the generative model 202 and/or the generative model 250.

In one example, the critique results can indicate suggestions for improving digital components generated by the generative model 202. The training data generation apparatus 214 can then include the suggestions for improving digital components in the training data for refining the generative model 202. By using this feedback loop to adjust the generative model 202 that creates new digital components, the adjusted generative model 202 can more precisely generate new digital components having higher quality than the digital components previously generated. In this way, the generative model 202 is improved by not wasting significant computing resources and power generating low quality content.

In another example, the generative model 250 can be trained using training digital components and their corresponding critique results. In some cases, one or more issues can be added to a training digital component intentionally. The critique results of the training digital component can include suggestion(s) on addressing the one or more issues. The training digital component can then be used to train the generative model 250.

The contents included in the training data can vary based on whether the generative model 202 (or the generative model 250) is an unsupervised ML model or a supervised ML model. In some implementations, the generative model 202 (or the generative model 250) is an unsupervised ML model trained using reinforcement learning algorithm(s). Reinforcement learning, also known as RL, is a ML approach used to solve problems by maximizing rewards or achieving specific targets through interactions between an agent and an environment, modeled as a Markov decision process (MDP). RL is an unsupervised learning method that relies on sequential feedback (e.g., rewards) from the environment. During the learning process, the agent observes the state of the environment, selects actions based on a policy, and receives feedback in the form of rewards or scores.

Through trial and error, the agent iteratively interacts with the environment, aiming to obtain a maximum reward or reach a specific target. Reward signals from the environment are used to evaluate a quality of the agent's actions rather than guiding the agent on how to perform correct actions. As the environment provides limited feedback, the agent learns through experience, acquires knowledge during interactions, and enhances an action selection policy to adapt to the environment.

More specifically, the learning process can involve the agent repeatedly observing the state of the environment, making decisions based on behavior, and receiving feedback. The objective of this learning can be to achieve an ideal state value function or policy. In some cases, the state value function can represent the expected cumulative rewards attainable by following the policy.

In one example, a state value function can be defined as:

$${V}^{π} ( s ) = {E}_{π} [ {R}_{t} \vert {s}_{t} = s ]$$

In this equation, Rt represents a long-term cumulative reward obtained through executing actions based on the policy x. The state value function represents an expectation of a cumulative reward brought by using the policy x starting from the state s.

As an example, assume that the digital components are images and the generative model 202 is trained to generate images based on the query and/or additional query data. The environment's state can include the following elements:
Query and/or additional query data.
Feedback on previously generated images: the feedback can be based on, for example, the critique results of the previously generated images.
   The state evolves as the generative model 202 iteratively generates images, receives feedback, and updates its policy.

The agent's action can be what the generative model 202 does in response to its current state. In this example, the agent's action can be to generate an image based on its current policy, the query and/or additional query data, and the feedback on previous generated images. The agent aims to learn a policy that leads to generating images that receive positive feedback, thus maximizing the received rewards while minimizing the penalties. The rewards and/or penalties can be determined based on a reward function.

The generative model 202's objective is to learn from these rewards and penalties to improve its digital component generation capabilities iteratively. Over time, the generative model 202 should generate digital components that are more likely to receive positive feedback, leading to better digital component generation performance. The reward function, in this case, acts as the “reinforcement signal” that guides the generative model 202's learning process.

In some implementations, when the ML model is an unsupervised ML model trained using RL algorithm(s), the AI system 160 can include, in the training data, at least one of a digital component (e.g., a digital component having positive critique results), an algorithm for generating the digital component, or a reward of the digital component. In some cases, the training data can include other digital component(s) and/or their corresponding data (e.g., other digital component(s), algorithm(s) for generating the other digital component(s), and/or reward(s) of the other digital component(s)).

The algorithm for generating the digital component can include, for example, one or more steps associated with generating the digital component based on original input digital component(s). In some cases, the algorithm for generating the digital component can occupy a smaller memory space than the digital component itself. So, in some cases, including the algorithm for generating the digital component in the training data can save storage space compared to including the entire digital component in the training data.

In some implementations, a reward of a digital component can be generated using a reward function. To output the reward of a digital component, the input(s) to the reward function can include, for example, at least a part of the critique results of the digital component.

In some cases, the generative model 202 and/or the generative model 250 can be trained using Reinforcement Learning from Human Feedback (RLHF) algorithms. In RLHF, at least a part of the training data is obtained from human evaluations. For example, suggestions for improving digital components can be obtained from human designers. Additionally, the human evaluations can be ranked higher than the ones generated by the generative model 250. Ranking human evaluations higher allows the generative model 202 to generate digital components that would more likely be accepted by human designs or allows the generative model 250 to generate designer-like design critiques.

In some examples, the generative model 202 is a supervised ML model. The input(s) to the supervised ML model can include one or more features, such as an input prompt (e.g., the initial input prompt 242), a query (e.g., the query 246), and/or the additional query data. The output of the supervised ML model can be, for example, a digital component (e.g., an image). The supervised ML model can be trained using a set of training data and a corresponding set of labels, where the training data can include multiple sets of data relating to multiple queries and the generated digital components for the multiple queries. For example, a piece of training data can include, as feature(s) of a sample, an input prompt, a query, and/or the additional query data. The label of the piece of training data can be, for example, a digital component corresponding to the feature(s) and having positive critique results. The ML model can be trained by optimizing a loss function based on a difference between the model's output during training and the corresponding label.

The training data generation apparatus 214 can store the generated training data in the training data database 222. For example, the training data database 222 can index the generated training data to the query for which the training data is generated and/or an entity associated with the generated training data, so that the generated training data can be retrieved from the training data database 222 for additional operations performed by the training data generation apparatus 214 and/or the AI system 160.

In some cases, the AI system 160 can refine, using the model refine apparatus 216, the generative model 202 using the training data. The model refine apparatus 216 can be implemented using at least one computing device (e.g., a device including one or more processors), and can include one or more ML models. In some cases, the model refine apparatus 216 can refine the generative model 202 immediately upon the occurrence of a particular event. For example, the generative model 202 can be re-trained when an accuracy of the generative model 202 satisfies (meets or below) a predetermined threshold. In some cases, the generative model 202 can be re-trained periodically (e.g., every seven days or thirty days) and/or re-trained when a certain amount of training data has been generated.

In some implementations, after a period of training and/or refining, the generative model 202 can satisfy one or more predetermined conditions. The one or more predetermined conditions can include, for example, an accuracy of the generative model 202 satisfies (meets or exceeds) a predetermined threshold (e.g., the overall scores of the digital components generated by the generative model 202 satisfy predetermined threshold(s)). When the generative model 202 satisfies the one or more predetermined conditions, the AI system 160 can enter the exploitation mode where the generative model 202's generated digital components can be returned to the client devices without being evaluated by the generative model 250.

While the operations described above pertain to training and refining the generative model 202, one of ordinary skill in the art can understand that the generative model 250 can be trained and refined using similar operations.

FIG. 3 is a flow chart of an example process 300 for using a generative model to evaluate AI-generated digital components and generate critique results for refining the digital components, according to an implementation of the present disclosure. Operations of the process 300 can be performed, for example, by the service apparatus 110 of FIG. 1, the AI system 160 of FIG. 2, or another data processing apparatus. The operations of the process 300 can also be implemented as instructions stored on a computer readable medium, which can be non-transitory. Execution of the instructions, by one or more data processing apparatus, causes the one or more data processing apparatus to perform operations of the process 300.

At 302, an AI system (e.g., the AI system 160) generates a digital component using a first generative model (e.g., the generative model 202). The operations can be similar to the operations associated with generating digital components described with respect to FIG. 2, and the details are omitted here for brevity.

At 304, the AI system generates critique results (e.g., the critique results 252) of the digital component using a second generative model (e.g., the generative model 250). The second generative model can evaluate the digital component in multiple ways by performing a plurality of various tasks. In some cases, the second generative model can perform at least one of a content understanding task, a user experience evaluation task, a policy review task, an entity attribute review task, and/or a performance understanding task to generate the critique results. These tasks are described in detail below.

### 1. Content Understanding Task

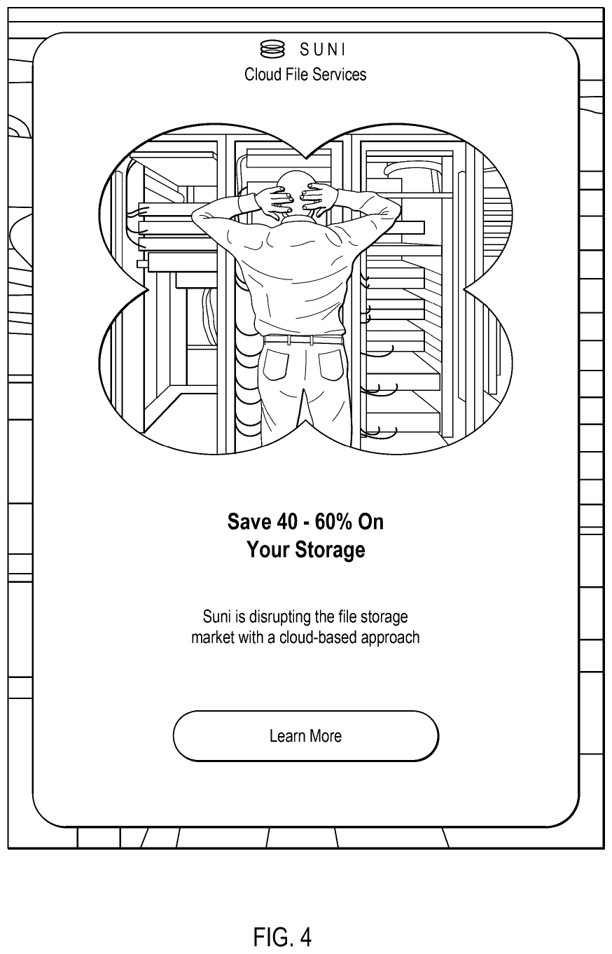

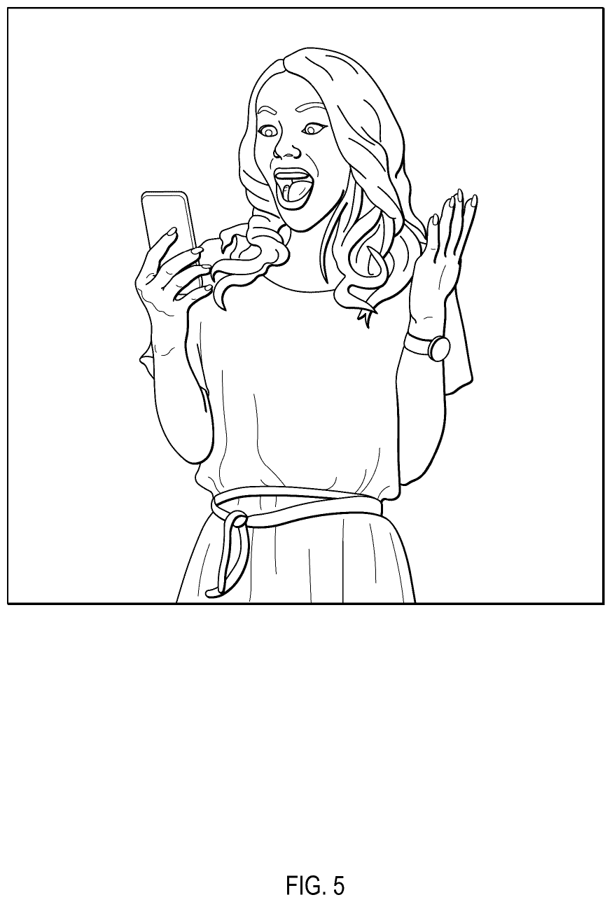

The second generative model can generate a summary of the digital component, the summary of the digital component indicating contents included in the digital component. FIGS. 4-5 show examples of digital components evaluated by the second generative model. In some cases, the AI system can provide an input prompt of “Tell me about this digital component” to the second generative model along with the digital component, and the second generative model can generate a summary of the digital component.

For example, regarding FIG. 4, the second generative model can generate the summary: This is a visual image for the AAA brand, which seems to be a BBBB business. The image uses the headline text CCCC and description text DDDD. There is a marketing image depicting EEEE. The overall aesthetic rating is good.

Regarding FIG. 5, the second generative model can generate the summary: This is a woman looking at a smartphone screen with an excited and surprised face. It can be used as a part of an image for some electronics or mobile based online services.

The content understanding task can enable CoT of the second generative model. The output of the second generative model (i.e., the critique results) can hugely improve because the content understanding task triggers the second generative model to do careful reasoning step by step like humans do. By first summarizing the digital component before the second generative model works on other tasks, the second generative model can better understand other tasks.

### 2. User Experience Evaluation Task

The generative model can generate an evaluation result (e.g., user experience evaluation result) of the digital component. The evaluation result of the digital component can indicate one or more suggestions for improving the digital component.

Use FIGS. 4-5 as examples. In FIG. 4, the AI system can provide an input prompt of “Please help me rate this image from the perspective of online digital component user experience” to the second generative model along with the digital component. The second generative model can generate the evaluation result: It looks comfortable and inspiring. The overall design looks professionally designed, especially the see-through window of flower shape.

Additionally, the AI system can provide an input prompt of “Please give some improvement suggestions about this image from the perspective of online digital component user experience” to the second generative model along with the digital component. The second generative model can generate this suggestion for improvement as the evaluation result: It has a minor issue. The headline text does not have enough contrast with its background, which makes a user a little hard to understand in a quick glance.

In FIG. 5, the AI system can provide an input prompt of “Please help me rate this image from the perspective of online digital component user experience” to the second generative model along with the digital component. The second generative model can generate the evaluation result: It looks amiable and attracts user's curiosities.

In some cases, the one or more suggestions for improving the digital component include identifications of pixels that need to be adjusted. For example, in the example above regarding headline text not having enough contrast with its background, the suggestion(s) for enhancing the digital component can pinpoint the exact locations of pixels needing additional contrast. Consequently, employing a generative model to evaluate digital components can detect issues at a more granular level compared to humans, who are unable to discern differences at the pixel level. This finer level of analysis ensures that the suggestions provided are highly detailed and actionable, leading to more effective improvements in digital component generations.

### 3. Policy Review Task

The second generative model can generate a policy review result of the digital component, the policy review result of the digital component indicating whether the digital component includes restricted content. In some cases, a digital component policy can specify that a digital component shall not include any restricted content. Examples of restricted content include but not limited to clickbait information, illegal or prohibited content (e.g., drug trafficking, piracy, hacking, or other criminal acts), violent or disturbing content, adult or explicit content, hate speech or offensive material, copyrighted material, misleading or deceptive content, gambling or betting information, sensitive topics (e.g., content discussing sensitive topics like self-harm, suicide, or mental health issues), restricted geographic content (e.g., certain content may be geographically restricted due to licensing agreements, legal restrictions, or cultural sensitivities), and political or election-related content.

Use FIG. 4 as an example. The AI system can provide an input prompt of “Does the digital component depict violent or criminal content such as guns, firearms, ammunition, explosives, fireworks, knives, prison, criminals, or arrests?” to the second generative model along with the digital component. The second generative model can generate the evaluation result: No, it looks peaceful.

### 4. Entity Attribute Review Task

The second generative model can generate an attribute review result of the digital component based on comparing one or more entity attributes of an entity associated with the digital component and one or more digital component attributes of the digital component. In some cases, the second generative model can determine one or more entity attributes of an entity associated with the digital component. The second generative model can also determine one or more digital component attributes of the digital component. The second generative model can compare the one or more entity attributes of the entity and the one or more digital component attributes of the digital component to generate an attribute review result of the digital component. In some cases, if the one or more entity attributes of the entity and the one or more digital component attributes of the digital component are the same, the attribute review result is positive. On the other hand, if the one or more entity attributes of the entity and the one or more digital component attributes of the digital component are different, the attribute review result is negative and suggests that the digital component can be refined to be consistent with the entity attribute(s) of the entity.

In some cases, the entity is a company who would use the generated digital component. Examples of entity attributes of companies can include but not limited to, down-to-earth, family-oriented, small-town, honest, sincere, real, wholesome, original, cheerful, sentimental, friendly, daring, trendy, exciting, spirited, cool, young, imaginative, unique, up-to-date, independent, contemporary, reliable, hard-working, secure, intelligent, technical, corporate, successful, leader, confident, upper-class, glamorous, good-looking, and any suitable entity attributes of companies.

In some cases, the entity is a publisher (e.g., a website or a mobile application) of the digital component. The attribute(s) of a publisher can be determined based on the design and/or style of the publisher. In some cases, the AI system can determine the attribute(s) of a publisher by parsing the screen shot(s) of the publisher's web page and/or mobile application.

The second generative model can determine whether the entity attribute(s) of the entity (e.g., brand personalities or traits) is consistent with the digital component attribute(s) of the digital component (e.g., traits of the digital component). Assume that the entity attribute of an entity is “family-oriented,” whereas the digital component attribute of the digital component is “reliable.” It indicates a mismatch of the entity attribute and the digital component attribute. The AI system and/or the second generative model can then suggest the first generative model to refine the digital component to be consistent with the entity attribute of the entity.

Use FIG. 4 as an example. The AI system can provide an input prompt of “Can you classify the digital component into one of the following entity attributes: honest, confident, secure, rugged, or reliable?” to the second generative model along with the digital component. The second generative model can output: Reliable.

### 5. Performance Understanding Task

The second generative model can generate a performance evaluation result of the digital component. The performance evaluation result of the digital component can include at least one of a predicted CTR, a predicted CVR, or a predicted CPD of the digital component. In some implementations, the second generative model can be trained to predict the performance of digital components. A positive performance evaluation result (e.g., a high predicted CTR, a high predicted CVR, or a high predicted CPD) can indicate that the quality of a digital component is high. On the other hand, a negative performance evaluation result (e.g., a low predicted CTR, a low predicted CVR, or a low predicted CPD) can indicate that the quality of a digital component is low and may need refinement.

The second generative model can perform any combination of the content understanding task, the user experience evaluation task, the policy review task, the entity attribute review task, and the performance understanding task to generate the critique results. The critique results can include at least one of the summary of the digital component, the evaluation result of the digital component, the policy review result of the digital component, the attribute review result of the digital component, or the performance evaluation result of the digital component.

In some cases, the second generative model can focus on specific regions to generate critique results. For example, the AI system and/or a user can specify target regions of a digital component for the second generative model to generate critique results. This allows to generate more targeted critique results.

At 306, the AI system refines, using the first generative model, the digital component based on the critique results of the digital component. The AI system can refine, using the first generative model, the digital component based on at least one of the summary of the digital component, the evaluation result of the digital component, the policy review result of the digital component, the attribute review result of the digital component, or the performance evaluation result of the digital component.

In some cases, the AI system can generate training data including the digital component and at least a part of the critique results (e.g., the one or more suggestions for improving the digital component). The AI system can refine the first generative model using the training data. In some examples, the AI system can generate training data comprising a training digital component and one or more suggestions for improving the training digital component. The AI system can train the second generative model using the training data. The operations for training/refining the first generative model and the second generative model can be similar to the operations associated with training/refining the generative model 202 and the generative model 250 described with respect to FIG. 2, and the details are omitted here for brevity.

In some examples, the AI system can display the critique results generated by the second generative model in a client device (e.g., the client device 204). In some examples, the AI system can display one or more pointers pointing to one or more regions of the digital component. The one or more regions of the digital component can be associated with the one or more suggestions for improving the digital component. For example, the AI system can display a pointer pointing to the headline text that needs more contrast with respect to its background.

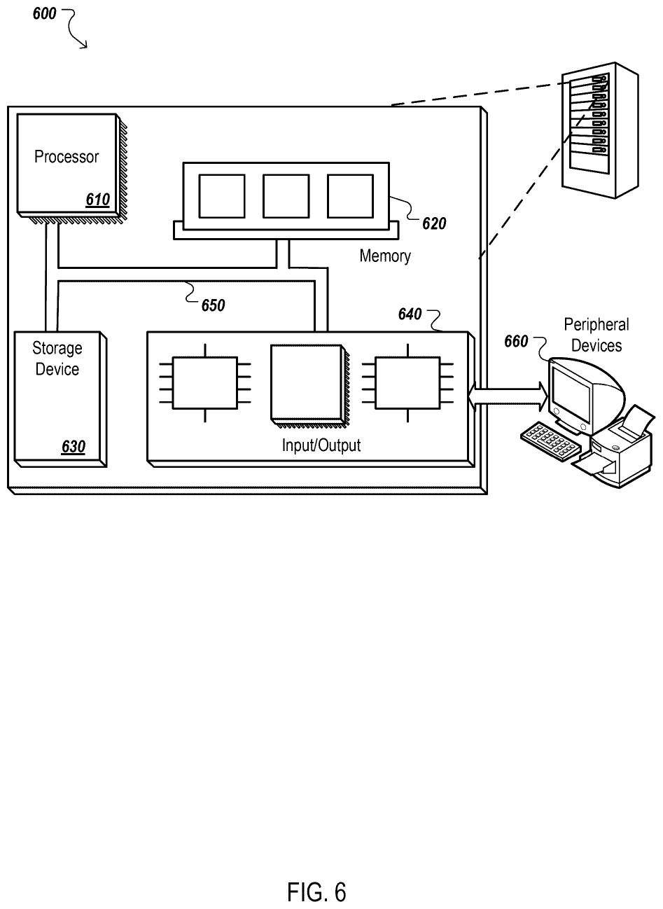

FIG. 6 is a block diagram of an example computer system 600 that can be used to perform described operations, according to an implementation of the present disclosure. The system 600 includes a processor 610, a memory 620, a storage device 630, and an input/output device 640. Each of the components 610, 620, 630, and 640 can be interconnected, for example, using a system bus 650. The processor 610 is capable of processing instructions for execution within the system 600. In one implementation, the processor 610 is a single-threaded processor. In another implementation, the processor 610 is a multi-threaded processor. The processor 610 is capable of processing instructions stored in the memory 620 or on the storage device 630.

The memory 620 stores information within the system 600. In one implementation, the memory 620 is a computer-readable medium. In one implementation, the memory 620 is a volatile memory unit. In another implementation, the memory 620 is a non-volatile memory unit.

The storage device 630 is capable of providing mass storage for the system 600. In one implementation, the storage device 630 is a computer-readable medium. In various different implementations, the storage device 630 can include, for example, a hard disk device, an optical disk device, a storage device that is shared over a network by multiple computing devices (e.g., a cloud storage device), or some other large capacity storage device.

The input/output device 640 provides input/output operations for the system 600. In one implementation, the input/output device 640 can include one or more network interface devices, e.g., an Ethernet card, a serial communication device, e.g., and RS-232 port, and/or a wireless interface device, e.g., and 802.11 card. In another implementation, the input/output device can include driver devices configured to receive input data and send output data to other devices, e.g., keyboard, printer, display, and other peripheral devices 660. Other implementations, however, can also be used, such as mobile computing devices, mobile communication devices, and set-top box television client devices.

Although an example processing system has been described in FIG. 6, implementations of the subject matter and the functional operations described in this specification can be implemented in other types of digital electronic circuitry, or in computer software, firmware, or hardware, including the structures disclosed in this specification and their structural equivalents, or in combinations of one or more of them.

An electronic document (which for brevity will simply be referred to as a document) does not necessarily correspond to a file. A document may be stored in a portion of a file that holds other documents, in a single file dedicated to the document in question, or in multiple coordinated files.

For situations in which the systems discussed here collect and/or use personal information about users, the users may be provided with an opportunity to enable/disable or control programs or features that may collect and/or use personal information (e.g., information about a user's social network, social actions or activities, a user's preferences, or a user's current location). In addition, certain data may be treated in one or more ways before it is stored or used, so that personally identifiable information associated with the user is removed. For example, a user's identity may be anonymized so that the no personally identifiable information can be determined for the user, or a user's geographic location may be generalized where location information is obtained (such as to a city, ZIP code, or state level), so that a particular location of a user cannot be determined.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus.

Alternatively, or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

This document refers to a service apparatus. As used herein, a service apparatus is one or more data processing apparatus that perform operations to facilitate the distribution of content over a network. The service apparatus is depicted as a single block in block diagrams. However, while the service apparatus could be a single device or single set of devices, this disclosure contemplates that the service apparatus could also be a group of devices, or even multiple different systems that communicate in order to provide various content to client devices. For example, the service apparatus could encompass one or more of a search system, a video streaming service, an audio streaming service, an email service, a navigation service, an advertising service, a gaming service, or any other service.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory (RAM) or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method, comprising:
generating, by an artificial intelligence (AI) system, a digital component using a first generative model;
generating, by the AI system, a summary of the digital component using a second generative model, the summary of the digital component indicating contents comprised in the digital component;
generating, by the AI system, an evaluation result of the digital component using the second generative model, the evaluation result of the digital component indicating one or more suggestions for improving the digital component; and
refining, by the AI system and using the first generative model, the digital component based on the summary of the digital component and the evaluation result of the digital component.

2. The computer-implemented method of claim 1, comprising:
generating, by the AI system, a policy review result of the digital component using the second generative model, the policy review result of the digital component indicating whether the digital component includes restricted content, wherein refining the digital component comprises:
refining, by the AI system and using the first generative model, the digital component based on the summary of the digital component, the evaluation result of the digital component, and the policy review result of the digital component.

3. The computer-implemented method of claim 1, comprising:
determining, by the AI system and using the second generative model, one or more entity attributes of an entity associated with the digital component;
determining, by the AI system and using the second generative model, one or more digital component attributes of the digital component; and
generating, by the AI system and using the second generative model, an attribute review result of the digital component based on comparing the one or more entity attributes of the entity and the one or more digital component attributes of the digital component, wherein refining the digital component comprises:
refining, by the AI system, the digital component based on the summary of the digital component, the evaluation result of the digital component, and the attribute review result of the digital component.

4. The computer-implemented method of claim 1, comprising:
generating, by the AI system and using the second generative model, a performance evaluation result of the digital component, wherein refining the digital component comprises:
refining, by the AI system, the digital component based on the summary of the digital component, the evaluation result of the digital component, and the performance evaluation result of the digital component.

5. The computer-implemented method of claim 4, wherein the performance evaluation result of the digital component comprises at least one of a predicted clickthrough rate (CTR) or a predicted conversion rate (CVR).

6. The computer-implemented method of claim 1, wherein a refined digital component is generated based on refining the digital component, and wherein the computer-implemented method comprises:
determining, by the AI system and using the second generative model, whether the refined digital component satisfies one or more conditions.

7. The computer-implemented method of claim 6, comprising:
in response to determining that the refined digital component satisfies the one or more conditions, outputting, by the AI system, the refined digital component.

8. The computer-implemented method of claim 6, comprising:
in response to determining that the refined digital component does not satisfy the one or more conditions:
generating, by the AI system, a summary of the refined digital component using the second generative model;
generating, by the AI system, an evaluation result of the refined digital component using the second generative model; and
refining, by the AI system and using the first generative model, the refined digital component based on the summary of the refined digital component and the evaluation result of the refined digital component.

9. The computer-implemented method of claim 1, comprising:
generating, by the AI system, training data comprising a training digital component and one or more suggestions for improving the training digital component; and
training, by the AI system, the second generative model using the training data.

10. The computer-implemented method of claim 1, comprising:
generating, by the AI system, training data comprising the digital component and the one or more suggestions for improving the digital component; and
refining, by the AI system, the first generative model using the training data.

11. The computer-implemented method of claim 1, comprising:
displaying, by the AI system, one or more pointers pointing to one or more regions of the digital component, the one or more regions of the digital component associated with the one or more suggestions for improving the digital component.

12. The computer-implemented method of claim 1, wherein the one or more suggestions for improving the digital component comprise identifications of pixels to be improved.

13. A computer-implemented artificial intelligence (AI) system comprising:
one or more processors; and
one or more storage devices storing instructions that, when executed by the one or more processors, cause the one or more processors to perform operations comprising:
generating, by the AI system, a digital component using a first generative model;
generating, by the AI system, a summary of the digital component using a second generative model, the summary of the digital component indicating contents comprised in the digital component;
generating, by the AI system, an evaluation result of the digital component using the second generative model, the evaluation result of the digital component indicating one or more suggestions for improving the digital component; and
refining, by the AI system and using the first generative model, the digital component based on the summary of the digital component and the evaluation result of the digital component.

14. The computer-implemented AI system of claim 13, the operations comprising:
generating, by the AI system, a policy review result of the digital component using the second generative model, the policy review result of the digital component indicating whether the digital component includes restricted content, wherein refining the digital component comprises:
refining, by the AI system and using the first generative model, the digital component based on the summary of the digital component, the evaluation result of the digital component, and the policy review result of the digital component.

15. The computer-implemented AI system of claim 13, the operations comprising:
determining, by the AI system and using the second generative model, one or more entity attributes of an entity associated with the digital component;
determining, by the AI system and using the second generative model, one or more digital component attributes of the digital component; and
generating, by the AI system and using the second generative model, an attribute review result of the digital component based on comparing the one or more entity attributes of the entity and the one or more digital component attributes of the digital component, wherein refining the digital component comprises:
refining, by the AI system, the digital component based on the summary of the digital component, the evaluation result of the digital component, and the attribute review result of the digital component.

16. The computer-implemented AI system of claim 13, the operations comprising:
generating, by the AI system and using the second generative model, a performance evaluation result of the digital component, wherein refining the digital component comprises:
refining, by the AI system, the digital component based on the summary of the digital component, the evaluation result of the digital component, and the performance evaluation result of the digital component.

17. The computer-implemented AI system of claim 16, wherein the performance evaluation result of the digital component comprises at least one of a predicted clickthrough rate (CTR) or a predicted conversion rate (CVR).

18. The computer-implemented AI system of claim 13, wherein a refined digital component is generated based on refining the digital component, and wherein the operations comprise:
determining, by the AI system and using the second generative model, whether the refined digital component satisfies one or more conditions.

19. The computer-implemented AI system of claim 18, the operations comprising:
in response to determining that the refined digital component satisfies the one or more conditions, outputting, by the AI system, the refined digital component.

20. One or more non-transitory computer readable medium storing instructions, that when executed by a computer-implemented artificial intelligence (AI) system, causes the computer-implemented AI system to perform operations comprising:
generating, by the AI system, a digital component using a first generative model;
generating, by the AI system, a summary of the digital component using a second generative model, the summary of the digital component indicating contents comprised in the digital component;
generating, by the AI system, an evaluation result of the digital component using the second generative model, the evaluation result of the digital component indicating one or more suggestions for improving the digital component; and
refining, by the AI system and using the first generative model, the digital component based on the summary of the digital component and the evaluation result of the digital component.
